(19) United States
(12) Patent Application Publication
(10) Pub. No.: US 2007/0076863 A1
(43) Pub. Date: Apr. 5, 2007

(54) Device and method for communication with the aid of an encrypted code table

(76) Inventors: Michael Schiffmann, Tuchenbach (DE); Bernhard Wiegickl, Vilseck (DE)

Correspondence Address: HARNESS, DICKEY & PIERCE, P.L.C., P.O.BOX 8910, RESTON, VA, 20195, US

(21) Appl. No.: 10/556,905

(22) PCT Filed: Apr. 2, 2004
(86) PCT No.: PCT/EP04/03535

§ 371 Date: Oct. 24, 2006

(30) Foreign Application Priority Data
May 16, 2003 (EP) 030112502.

(51) Int. Cl. H04L 9/28

(52) U.S. Cl. 380/28

(57) ABSTRACT

In order to maintain the required security, an interface specific code is stored in an encrypted manner in a code memory which is integrated in a communication processor. In the event of an error in the communication processor, the original code is not transmitted but, if necessary, the encrypted code is transmitted. Only an external decoder is necessary to decode the code. The decoder ensures the necessary physical separation of the components in the initialisation of the code which is to be transferred.

This application is the national phase under 35 U.S.C. § 371 of PCT International Application No. PCT/EP2004/003535 which has an International filing date of Apr. 2, 2004, which designated the United States of America and which claims priority on European Patent Application number EP 03011250.2 filed May 16, 2003, the entire contents of which are hereby incorporated herein by reference.

### FIELD

The present invention generally relates to a communication processor apparatus for communication in a network having a processor device for processing incoming signals and for production and/or provision of outgoing signals, and/or to a code memory device for provision of a code for the processor device. The present invention also generally relates to a corresponding method for communication in a network.

### BACKGROUND

The so-called actuator sensor interface (AS-i) can be used in low-level buses for industrial applications. The actuator sensor interface is described in detail on the Internet at the address “www.as-interface.net”.

A code sequence which is unique for this network and typically comprises 4×8 bits is stored in each slave in an AS-i network for transmission of safety-relevant or security-relevant data via an AS interface. A detailed description of a code sequence such as this can be found in the compendium “AS-Interface - Die Lösung in der Automation” AS-i [AS interface—the solution in automation], February 2003, pages 134 et seqq.

The code sequence is stored in a component which is isolated from an AS-i communication processor. The isolation of the communication processor and code memory makes it possible to prevent undesired transmission of the code sequence for example as a result of a short circuit or an inaccurate manufacturing process. Safety-relevant and security-relevant components and conductor tracks must primarily be physically isolated from one another in order to make it possible to ensure the required preclusion of errors and faults. Depending on the potentials and materials used, specific minimum separations must be complied with in this case. The minimum separations are, for example, 0.2 mm. For this reason, a code memory cannot be integrated in the communication processor.

### SUMMARY

An object of at least one embodiment of the present invention is to propose a simplified communication processor apparatus and/or a corresponding communication method.

According to at least one embodiment of the invention, an object may be achieved by a communication processor apparatus for communication in a network having a processor device for processing incoming signals and for production and/or provision of outgoing signals, and a code memory device for provision of a code for the processor device, in which the code memory device is integrated in the processor device, the code is in an encrypted form in the code memory device, and the processor device can be connected to an external decoder device for decryption of at least a part of the code.

Furthermore, at least one embodiment of the invention provides a method for communication in a network, comprising: provision of a code and comparison of data with the code and/or transmission of the code into the network, in which the code is provided in an encrypted form in a communication processor apparatus at least a part of the encrypted code is decrypted outside the communication processor apparatus, and the decrypted code is made available to the communication processor apparatus.

Since the code is stored in an encrypted form in the communication processor, no valid code sequence is transmitted in the event of an error or fault in the communication processor. It is thus also possible for the code memory to be integrated in the communication processor avoiding the physical separation in accordance with the regulations of, for example, at least 0.2 mm between safety-relevant or security-relevant assemblies within an integrated circuit.

A common circuit such as this for the communication processor and the code memory device may be in the form of an ASIC, for example.

Encryption information and decryption information may also be stored in the code memory device, and may be made available to the decoding device. The external decoding device can thus be made simpler, since there is no need to store all of the decryption information in the decoding device.

The code memory device may have an input device for inputting an encrypted code. This allows the code to be stored in the communication processor apparatus and to be edited as required, for example by use of a PC.

The communication processor apparatus may also have an interchanging device, by which at least two digits in the multiple digit code can be interchanged. The interchanging process is used for partial decryption of the encrypted code. In general, at least part of the decryption process can be carried out directly in the communication processor apparatus.

The communication processor apparatus may advantageously be used for an actuator sensor interface for communication in an AS-i network.

### BRIEF DESCRIPTION OF THE DRAWINGS

The present invention will now be explained in more detail with reference to example embodiments and the attached drawings, in which:

FIG. 1 shows a circuit design for a communication processor apparatus according to the prior art;

FIG. 2 shows a circuit design for a communication processor apparatus according to at least one embodiment of the present invention;

FIG. 3 shows code tables based on a first embodiment;

FIG. 4 shows code tables based on a second embodiment; and

FIG. 5 shows a specific circuit design for use of the code tables in FIG. 4.

### DETAILED DESCRIPTION OF THE EXAMPLE EMBODIMENTS

The embodiments which are described in the following text represent preferred example embodiments of the present invention.

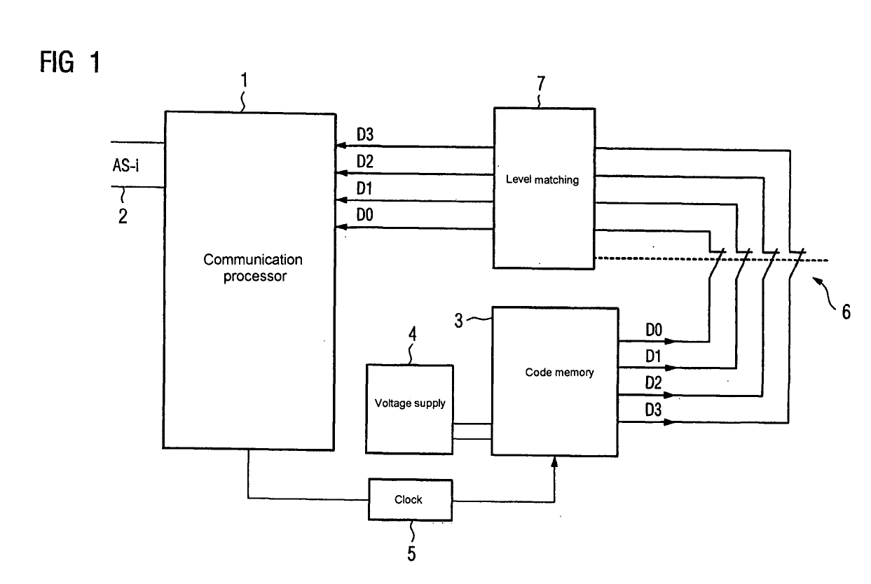

In order to describe example embodiments of the invention, the basic circuit diagram of a communication processor apparatus according to the prior art will first of all be explained in more detail with reference to FIG. 1. A communication processor 1 transmits and receives data from an AS-i line 2. The code which is specific for the AS interface is stored in a code memory 3, which is equipped with its own voltage supply 4. The code memory 3 is connected via a timer 5 to the communication processor 1, and receives the necessary clock pulses from it.

The code memory 3 has four parallel outputs D0, D1, D2 and D3 for transmission of a four-digit code message in one AS-i cycle. The output lines D0 to D3 are passed to the communication processor 1 via a switching apparatus 6 and a level matching device 7. The switching device 6 may, for example, be in the form of an emergency-off switch, so that all of the lines are open, and zero is transmitted in each case, in the off state. This corresponds to the emergency-off state in accordance with the AS-i specification. The level matching device 7 matches the levels of the two separate assemblies to one another, specifically the communication processor 1 and the code memory 3.

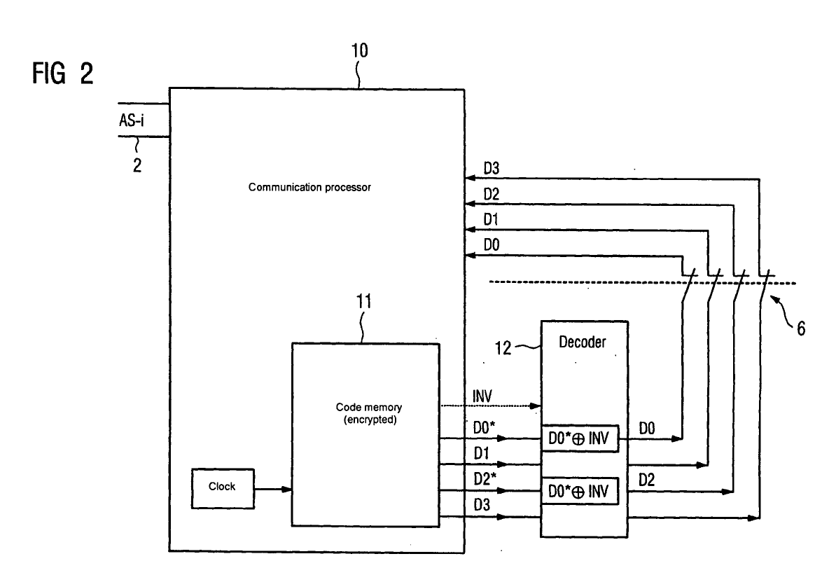

According to at least one embodiment of the invention, a code memory 11 is now integrated in the communication processor 10, as illustrated in FIG. 2. There is therefore no longer any need for the code memory to have its own voltage supply. The code memory 11 is still clocked by the communication processor 10.

In order to achieve the required level of safety and security, the code is stored in an encrypted form in the code memory 11. Furthermore, decryption information is also stored in the code memory 11, and is transmitted via a line INV in parallel with the output lines D0*, D1, D2*, D3 to an external decoder 12. The lines D0* and D2* symbolize that the code is transmitted in an encrypted form at these digits and/or in these lines. The digits D0* and D2* are decrypted to form D0 and D2 by means of a specific decoding operation.

In the present example, the decoding operation is carried out by an exclusive-OR operation on the encrypted digit D0* or D2*, using decryption information INV. All of the uncoded or decoded digits D0 to D3 are now passed from the output lines of the decoder 12, via the switching device 6, to the communication processor 10.

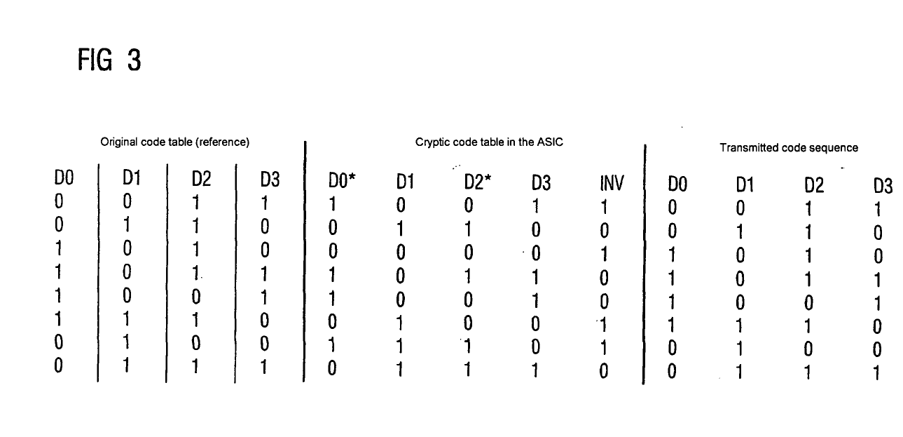

FIG. 3 uses an example to show the codes which are processed or created in the circuit shown in FIG. 2. That 4×8 code sequence which represents the AS interface-specific code in the original is illustrated on the left-hand side. An encrypted 4×8 code sequence, including decryption information INV for each of the eight code messages, is illustrated in the center of FIG. 3. Finally, the code is shown on the right-hand side of FIG. 3, as it is fed into the communication processor 10. The transmitted code sequence corresponds exactly to the original code sequence shown on the left-hand side.

The control mechanism for the cryptic code table that is illustrated in the center of FIG. 3 and is stored in the communication processor 10, which is in the form of an ASIC, is as follows:
D0*=D0 ⊕ INV, and likewise
D2*=D2 ⊕ INV.

In this case, the “⊕” symbolizes an exclusive-OR operation. The encryption and/or decryption information INV comprises one bit, filled with a 0 or 1 in a fixed or variable form, for the n code values. In the present example, INV is filled with a 1 for the first, third, sixth and seventh code values, and is filled with a 0 for the other code values. The INV information is also stored in the code memory 11, associated with the code value. The digits D0 and D3 in the code table stored in the code memory 11 are unchanged, and correspond to the original code.

The code table to be transmitted is recovered from the cryptic code table (see the center of FIG. 3) stored in the communication processor 10 or the ASIC, as follows: The INV information is emitted at an ASIC pin. D0=D0* ⊕ INV and D2=D2* ⊕ INV are formed in the external decoder, and are transmitted. D1 and D3 are passed through the decoder 12 and are transmitted.

If the cryptic code table is compared with the code sequence that is transmitted in the end and is expected by a safety or security monitor, it can easily be seen that ASIC-internal errors or faults cannot result in undesired transmission of the valid code table.

According to at least one embodiment of the invention, this thus results in the advantage that, in comparison to the circuit design shown in FIG. 1, it is possible to save a plurality of external circuit elements, specifically the external code memory 3, the voltage supply 4 for the code memory 3, the timer 5 and the level matching device 7, without any restriction to the safety or security category. These circuit elements are either already available or are not (or are no longer) necessary in the communication processor, or else can be integrated in it on a virtually cost-neutral basis. This results in considerable cost savings for a safe or secure AS-i slave, with a considerably reduced space requirement.

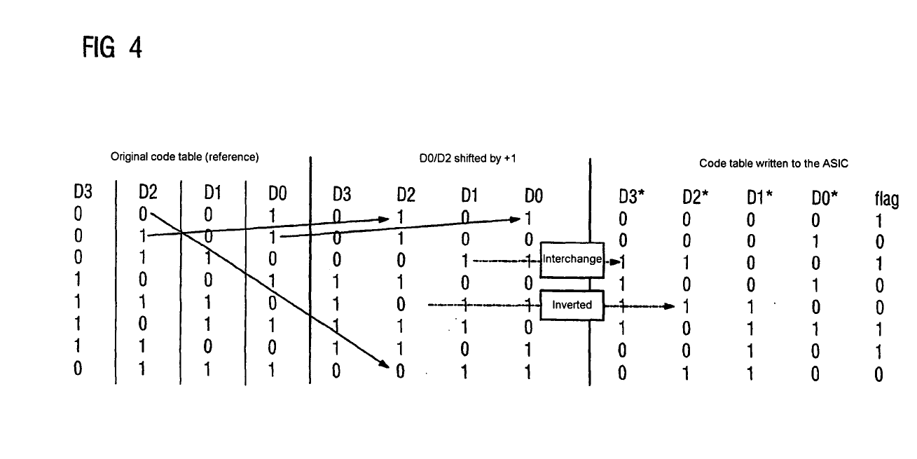

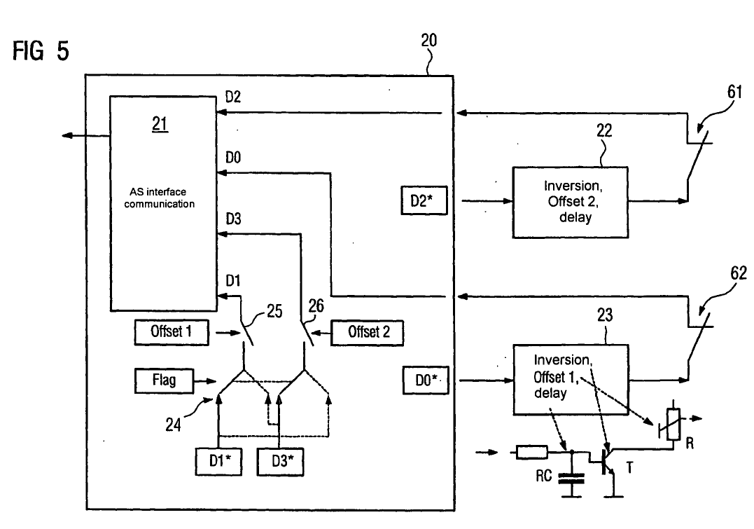

An alternative embodiment relating to the encryption and decryption of the code tables will be described with reference to FIGS. 4 and 5. The original code table is once again illustrated as a reference on the left-hand side of FIG. 4. In a first encryption step, the values in the code table are shifted by +1, that is to say upward, at the digits D0 and D2. This shift is shown in the central table in FIG. 2. In a second encryption step, values in the table are interchanged and/or inverted, as is illustrated in the right-hand table in FIG. 4. These resultant values are written to the code memory 11, which is integrated in the communication processor. In addition, a flag is stored in the code memory 11 for every four-digit code message.

The control mechanism for the cryptographic code table in the ASIC in FIG. 4 is: D0 and D2 are shifted “forward” by one value and are inverted before being stored in the ASIC. D1 and D3 are interchanged for the first, third, sixth and seventh code values (in a fixed or else variable form for a total of four code values). These code values are identified by 1 for a fifth bit (flag). The code values with the D1/D3 bit, which has not been interchanged, are identified by the flag=0. The flag information is also stored, associated with the code value.

The transmitted code table is recovered from the cryptographic code table in the ASIC on the basis of the circuit illustrated in FIG. 5. The values D0* and D2*, which originate from the communication processor apparatus 20, are inverted in external circuit parts 22 and 23, are provided with an offset voltage Offset 1 or Offset 2, respectively, and are thus delayed (by about 20 μs), such that D0* and D2* are not transmitted until the next AS interface cycle. For this purpose, the decrypted values D0 and D2 are passed back via switches 61 and 62 to the communication processor apparatus 20, or to the communication processor 21 contained in it. The circuit parts 22 and 23 each have an RC element RC to produce the delay, a transistor T connected to it to produce the inversion, and a voltage divider R to set the offset.

The values D1 and D3 are passed on internally in the communication processor apparatus and the ASIC 20, respectively, as a function of the offset voltages Offset 1 and Offset 2, which are produced in the presence of D0* and D2*, for transmission to the AS interface. For this purpose, the values D1* and D3* are interchanged by an internal switching device 24 in accordance with a flag. If the flag (see the right-hand table in FIG. 4) is 0, the values D1* and D3* are not interchanged, and are passed on directly as D1 and D3 to the communication processor 21 via switches 25 and 26. These internal switches 25 and 26 are controlled via the offset voltages Offset 1 and Offset 2. For this purpose, a tap is provided for the lines D0 and D2.

If the external switches 61 and 62 are closed, the signals are each provided with an offset in the lines D0 and D2. These offset voltages are used to keep the internal switches 25 and 26 closed. If the AS interface is now disconnected, for example via an emergency-off switch, the two switches 61 and 62 are opened. The offset voltages Offset 1 and Offset 2 are no longer applied to the internal switches 25 and 26, so that they also open. A zero signal is thus present on all the lines D0 to D3, thus resulting in the required state in accordance with the AS-i specification.

In principle, any other desired code tables and code sequences are also possible. The advantages mentioned above in conjunction with FIGS. 2 and 3 are also applicable to this embodiment.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A communication processor apparatus for communication in a network, comprising:
a processor to process incoming signals and to at least one of produce and provision outgoing signals; and
a code memory, integrated in the processor, to provision a code for the processor,
the code being in an encrypted form in the code memory, and
the processor connectable to an external decoder to decrypt at least a part of the code.

2. The communication processor apparatus as claimed in claim 1, in wherein the processor and the code memory are formed by a common integrated circuit.

3. The communication processor apparatus as claimed in claim 2, wherein the common circuit is an ASIC.

4. The communication processor apparatus as claimed in claim 1, wherein decryption information, available to the decoder, is also stored in the code memory.

5. The communication processor apparatus as claimed in claim 1, wherein the code memory includes an input device for inputting an encrypted code.

6. The communication processor apparatus as claimed in claim 1, further comprising an interchanging device to interchange at least two digits in the multiple digit code for decryption.

7. An actuator sensor interface including a communication processor apparatus as claimed in claim 1.

8. A method for communication in a network, comprising:
provisioning a code in an encrypted form in a communication processor apparatus; and
comparing data with at least one of the code and transmission of the code into the network; and
decrypting at least a part of the encrypted code outside the communication processor apparatus,
the decrypted code being made available to the communication processor apparatus.

9. The method as claimed in claim 8, wherein decryption information is also stored together with the encrypted code in the communication processor apparatus, and is made available for decryption.

10. The method as claimed in claim 8 wherein the encrypted code is generated externally and is input to the communication processor apparatus.

11. The method as claimed in claim 8, wherein the code is a multiple digit code and at least two digits are interchanged in the communication processor apparatus for decryption.

12. The method as claimed in claim 8, wherein the communication takes place in an AS-i network.

13. A communication processor apparatus for communication in a network, comprising:
processor means for processing incoming signals and for at least one of producing and provisioning outgoing signals; and
code memory means, integrated in the processor device, for provisioning of a code for the processor device, the code being in an encrypted form in the code memory means, and the processor means being connectable to an external decoder for decryption of at least a part of the code.

14. The communication processor apparatus as claimed in claim 13, wherein the processor means and the code memory means are formed by a common integrated circuit.

15. The communication processor apparatus as claimed in claim 14, wherein the common circuit is an ASIC.

16. The communication processor apparatus as claimed in claim 13, wherein decryption information, available to the decoder, is also stored in the code memory means.

17. The communication processor apparatus as claimed in claim 13, wherein the code memory means includes an input means for inputting an encrypted code.

18. The communication processor apparatus as claimed in claim 13, further comprising an interchanging means for interchanging at least two digits in the multiple digit code for decryption.

19. An actuator sensor interface including a communication processor apparatus as claimed in claim 13.

20. The method as claimed in claim 9, wherein the encrypted code is generated externally and is input to the communication processor apparatus.
